(19) United States
(12) Patent Application Publication
(10) Pub. No.: US 2025/0350682 A1
(43) Pub. Date: Nov. 13, 2025

(54) SYSTEMS AND METHODS RELATED TO CUSTOMER AUTHENTICATION OF INCOMING TELEPHONE CALLS FROM AGENTS

(71) Applicant: GENESYS CLOUD SERVICES, INC., MENLO PARK, CA (US)

(72) Inventor: DAN SHAKED, TEL AVIV (IL)

(73) Assignee: GENESYS CLOUD SERVICES, INC., MENLO PARK, CA (US)

(21) Appl. No.: 18/661,261

(22) Filed: May 10, 2024

(51) Int. Cl. H04M 3/42

(52) U.S. Cl. CPC H04M 3/42059; H04M 2203/6045; H04M 2203/6081

(57) ABSTRACT

A method of verifying that incoming telephone calls to respective customers originate from a business entity known to the customers that includes: receiving data transmitted from a customer application on a first customer device that notifies of a triggering event occurring; generating a business-side version of the verification code for use in association with the first authentication attempt; generating, by the first customer device, a customer-side version of the verification code for use in association with the first authentication attempt; generating a user interface showing the customer-side version of the verification code; and transmitting the generated business-side version of the verification code to a first agent device for authenticating that the first telephone call originates from a first business entity by enabling a comparison verifying that the customer-side version and the business-side version of the verification code are equal.

### BACKGROUND

The present invention generally relates to customer relations services and customer relations management via contact centers and associated cloud-based systems. More particularly, but not by way of limitation, the present invention pertains to methods and systems allowing customers to verify that an incoming telephone call originated from a known or trusted business entity.

### BRIEF DESCRIPTION OF THE INVENTION

The present invention includes a method of verifying that incoming telephone calls to respective customers originate from a business entity known to the customers. The method includes the step of transmitting, from one or more servers associated with the business entity, a customer application to a customer device of each of the customers for installation on the customer device. The customer application identifies the business entity associated therewith and is configured to: determine an occurrence of a triggering event signaling an authentication attempt for authenticating a telephone call to a one of the customers; generate, in response to determining the occurrence of the triggering event, a customer-side version of a verification code for use in each authentication attempt; and generate a user interface on the customer device that displays the generated customer-side version of a verification code. The method may further include the step of performing an authentication process in relation to each authentication attempt. When described in relation to an exemplary first authentication attempt related to authenticating that a first telephone call initiated from a first agent device by an agent to a first customer device associated with a first customer originates from a first business entity, the authentication process includes the steps of: receiving, by a verification module disposed within the one or more servers, data transmitted from the customer application on the first customer device that notifies of the triggering event occurring; generating, by the verification module, a business-side version of the verification code for use in association with the first authentication attempt; generating, by customer application on the first customer device, the customer-side version of the verification code for use in association with the first authentication attempt; generating, by customer application on the first customer device for display on the first customer device, the user interface showing the customer-side version of the verification code; transmitting, by the one or more servers, the generated business-side version of the verification code to the first agent device for authenticating that the first telephone call originates from the first business entity by enabling a comparison verifying that the customer-side version of the verification code and the business-side version of the verification code are equal.

These and other features of the present application will become more apparent upon review of the following detailed description of the example embodiments when taken in conjunction with the drawings and the appended claims.

### BRIEF DESCRIPTION OF THE DRAWINGS

A more complete appreciation of the present invention will become more readily apparent as the invention becomes better understood by reference to the following detailed description when considered in conjunction with the accompanying drawings, in which like reference symbols indicate like components, wherein:

FIG. 1 depicts a schematic block diagram of a computing device in accordance with exemplary embodiments of the present invention and/or with which exemplary embodiments of the present invention may be enabled or practiced;

FIG. 2 depicts a schematic block diagram of a communications infrastructure or contact center in accordance with exemplary embodiments of the present invention and/or with which exemplary embodiments of the present invention may be enabled or practiced;

FIG. 3 is a simplified network diagram of a system in accordance with exemplary operation of embodiments of the present invention and/or with which exemplary embodiments of the present invention may be enabled or practiced;

FIG. 4 is an exemplary method of agent authentication according to an embodiment of the present invention;

FIG. 5 is an exemplary user interface of a smart phone in accordance with an exemplary embodiment of the present invention; and

FIG. 6 is another exemplary user interface of a smart phone in accordance with an exemplary embodiment of the present invention.

### DETAILED DESCRIPTION

For the purpose of promoting an understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail in order to avoid obscuring the present invention. Additionally, further modification in the provided examples or application of the principles of the invention, as presented herein, are contemplated as would normally occur to those skilled in the art. Particular features, structures or characteristics may be combined in any suitable combinations and/or sub-combinations in one or more embodiments or examples. Those skilled in the art will recognize that various embodiments may be computer implemented using many different types of data processing equipment, with embodiments being implemented as an apparatus, method, or computer program product. Example embodiments, thus, may take the form of a hardware embodiment, a software embodiment, or combination thereof.

### Computing Device

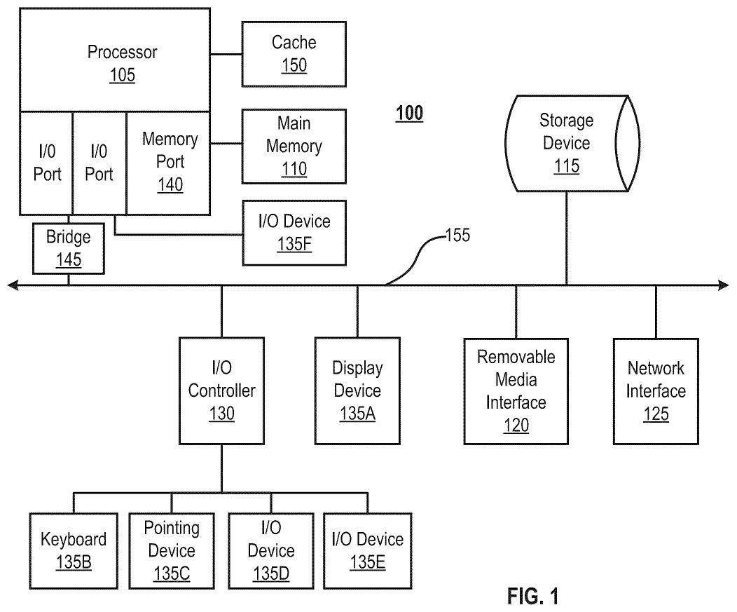

The present invention may be computer implemented using different forms of data processing equipment, for example, digital microprocessors and associated memory, executing appropriate software programs. By way of background, FIG. 1 illustrates a schematic block diagram of an exemplary computing device 100 in accordance with embodiments of the present invention and/or with which those embodiments may be enabled or practiced.

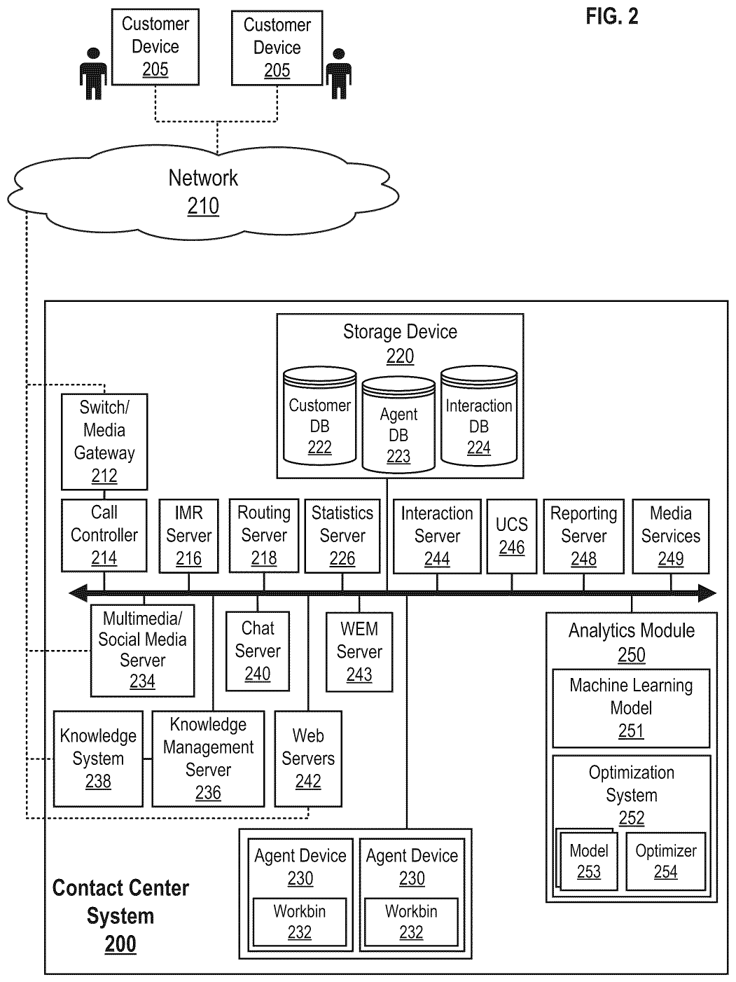

The computing device 100, for example, may be implemented via firmware (e.g., an application-specific integrated circuit), hardware, or a combination of software, firmware, and hardware. Each of the servers, controllers, switches, gateways, engines, and/or modules in the following figures (which collectively may be referred to as servers or modules) may be implemented via one or more of the computing devices 100. As an example, the various servers may be a process running on one or more processors of one or more computing devices 100, which may be executing computer program instructions and interacting with other systems or modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described in the following figures—such as, for example, the contact center 200 of FIG. 2—the various servers and computer devices thereof may be located on local computing devices 100 (i.e., on-site or at the same physical location as contact center agents), remote computing devices 100 (i.e., off-site or in a cloud computing environment, for example, in a remote data center connected to the contact center via a network), or some combination thereof. Functionality provided by servers located on off-site computing devices may be accessed and provided over a virtual private network (VPN), as if such servers were on-site, or the functionality may be provided using a software as a service (SaaS) accessed over the Internet using various protocols, such as by exchanging data via extensible markup language (XML), JSON, and the like.

As shown in the illustrated example, the computing device 100 may include a central processing unit (CPU) or processor 105 and a main memory 110. The computing device 100 may also include a storage device 115, removable media interface 120, network interface 125, I/O controller 130, and one or more input/output (I/O) devices 135, which as depicted may include an, display device 135A, keyboard 135B, and pointing device 135C. The computing device 100 further may include additional elements, such as a memory port 140, a bridge 145, I/O ports, one or more additional input/output devices 135D, 135E, 135F, and a cache memory 150 in communication with the processor 105.

The processor 105 may be any logic circuitry that responds to and processes instructions fetched from the main memory 110. For example, the processor 105 may be implemented by an integrated circuit, e.g., a microprocessor, microcontroller, or graphics processing unit, or in a field-programmable gate array or application-specific integrated circuit. As depicted, the processor 105 may communicate directly with the cache memory 150 via a secondary bus or backside bus. The main memory 110 may be one or more memory chips capable of storing data and allowing stored data to be accessed by the central processing unit 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices, for example, may include a keyboard 135B and a pointing device 135C, e.g., a mouse or optical pen. Output devices, for example, may include video display devices, speakers, and printers. More generally, the I/O devices 135 may include any conventional devices for performing the functionality described herein.

Unless otherwise limited, the computing device 100 may be any workstation, desktop computer, laptop or notebook computer, server machine, virtualized machine, mobile or smart phone, portable telecommunication device, media playing device, or any other type of computing, telecommunications or media device, without limitation, capable of performing the operations and functionality described herein. The computing device 100 may include a plurality of such devices connected by a network or connected to other systems and resources via a network. Unless otherwise limited, the computing device 100 may communicate with other computing devices 100 via any type of network using any conventional communication protocol.

### Contact Center

With reference now to FIG. 2, a communications infrastructure or contact center system (or simply “contact center”) 200 is shown in accordance with exemplary embodiments of the present invention and/or with which exemplary embodiments of the present invention may be enabled or practiced. By way of background, customer service providers generally offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between agents and customers may be conducted over a variety of communication channels, such as, for example, via voice (e.g., telephone calls or voice over IP or VOIP calls), video (e.g., video conferencing), text (e.g., emails and text chat), screen sharing, co-browsing, or the like.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize automated processes in place of live agents, such as interactive voice response (IVR) systems, interactive media response (IMR) systems, internet robots or “bots”, automated chat modules or “chatbots”, and the like.

Referring specifically to FIG. 2, the contact center 200 may be used by a customer service provider to provide various types of services to customers. For example, the contact center 200 may be used to engage and manage interactions in which automated processes (or bots) or human agents communicate with customers. The contact center 200 may be an in-house facility of a business or enterprise for performing the functions of sales and customer service relative to products and services available through the enterprise. In another aspect, the contact center 200 may be operated by a service provider that contracts to provide customer relation services to a business or organization. Further, the contact center 200 may be deployed on equipment dedicated to the enterprise or third-party service provider, and/or deployed in a remote computing environment such as, for example, a private or public cloud environment with infrastructure for supporting multiple contact centers for multiple enterprises. The contact center 200 may include software applications or programs, which may be executed on premises or remotely or some combination thereof. It should further be appreciated that the various components of the contact center 200 may be distributed across various geographic locations.

Unless otherwise specifically limited, any of the computing elements of the present invention may be implemented in cloud-based or cloud computing environments. As used herein, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture”, a cloud execution model generally includes a service provider dynamically managing an allocation and provisioning of remote servers for achieving a desired functionality.

In accordance with the illustrated example of FIG. 2, the components or modules of the contact center 200 may include: a plurality of customer devices 205; communications network (or simply “network”) 210; switch/media gateway 212; call controller 214; interactive media response (IMR) server 216; routing server 218; storage device 220; statistics server 226; plurality of agent devices 230 that each have a workbin 232; multimedia/social media server 234; knowledge management server 236 coupled to a knowledge system 238; chat server 240; web servers 242; interaction server 244; universal contact server (or “UCS”) 246; reporting server 248; media services server 249; and an analytics module 250. It should be understood that any of the computer-implemented components, modules, or servers described in relation to FIG. 2 or in any of the following figures may be implemented via computing devices, such as the computing device 100 of FIG. 1. As will be seen, the contact center 200 generally manages resources (e.g., personnel, computers, telecommunication equipment, etc.) to enable the delivery of services via telephone, email, chat, or other communication mechanisms. The various components, modules, and/or servers of FIG. 2 (and other figures included herein) each may include one or more processors executing computer program instructions and interacting with other system components for performing the various functionalities described herein. Further, the terms “interaction” and “communication” are used interchangeably, and generally refer to any real-time and non-real-time interaction that uses any communication channel including, without limitation, telephone calls (PSTN or VOIP calls), emails, voicemails, video, chat, screen-sharing, text messages, social media messages, WebRTC calls, etc. Access to and control of the components of the contact system 200 may be affected through user interfaces (UIs) which may be generated on the customer devices 205 and/or the agent devices 230.

Customers desiring to receive services from the contact center 200 may initiate inbound communications (e.g., telephone calls, emails, chats, etc.) to the contact center 200 via a customer device 205. While FIG. 2 shows two such customer devices it should be understood that any number may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center 200, such as telephone calls, emails, chats, text messages, web-browsing sessions, and other multi-media transactions. Inbound and outbound communications from and to the customer devices 205 may traverse the network 210, with the nature of network typically depending on the type of customer device being used and form of communication. As an example, the network 210 may include a communication network of telephone, cellular, and/or data services. The network 210 may be a private or public switched telephone network (PSTN), local area network (LAN), private wide area network (WAN), and/or public WAN such as the Internet. Further, the network 210 may include a wireless carrier network including a code division multiple access network, global system for mobile communications (GSM) network, or any wireless network/technology conventional in the art.

The switch/media gateway 212 may be coupled to the network 210 for receiving and transmitting telephone calls between customers and the contact center 200. The switch/media gateway 212 may include a telephone or communication switch configured to function as a central switch for agent routing within the center. The switch may be a hardware switching system or implemented via software. For example, the switch 215 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. In general, the switch/media gateway 212 establishes a voice connection between the customer and the agent by establishing a connection between the customer device 205 and agent device 230. The switch/media gateway 212 may be coupled to the call controller 214 which, for example, serves as an adapter or interface between the switch and the other routing, monitoring, and communication-handling components of the contact center 200. The call controller 214 may be configured to process PSTN calls, VOIP calls, etc. The call controller 214 may include computer-telephone integration (CTI) software for interfacing with the switch/media gateway and other components. The call controller 214 may extract data about an incoming interaction, such as the customer's telephone number, IP address, or email address, and then communicate these with other contact center components in processing the interaction.

The interactive media response (IMR) server 216 enables self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. Through continued interaction with the IMR server 216, customers may receive service without needing to speak with an agent. The IMR server 216 may ascertain why a customer is contacting the contact center so to route the communication to the appropriate resource.

The routing server 218 routes incoming interactions. For example, once it is determined that an inbound communication should be handled by a human agent, functionality within the routing server 218 may select the most appropriate agent and route the communication thereto. This type of functionality may be referred to as predictive routing. Such agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described more below, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230, which may enhance the service the agent is able to provide.

Regarding data storage, the contact center 200 may include one or more mass storage devices—represented generally by the storage device 220—for storing data in one or more databases. For example, the storage device 220 may store customer data that is maintained in a customer database 222. Such customer data may include customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database 223. Agent data maintained by the contact center 200 may include agent availability and agent profiles, schedules, skills, average handle time, etc. As another example, the storage device 220 may store interaction data in an interaction database 224. Interaction data may include data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center 200 in ways that facilitate the functionality described herein. For example, the servers or modules of the contact center 200 may query such databases to retrieve data stored therewithin or transmit data thereto for storage.

The statistics server 226 may be configured to record and aggregate data relating to the performance and operational aspects of the contact center 200. Such information may be compiled by the statistics server 226 and made available to other servers and modules, such as the reporting server 248, which then may produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center 200 may be communication devices configured to interact with the various components and modules of the contact center 200 to facilitate the functionality described herein. An agent device 230, for example, may include a telephone adapted for regular telephone calls or VOIP calls. An agent device 230 may further include a computing device configured to communicate with the servers of the contact center 200, perform data processing associated with operations, and interface with customers via voice, chat, email, and other multimedia communication mechanisms according to functionality described herein. While only two such agent devices are shown, any number may be present.

The multimedia/social media server 234 may be configured to facilitate media interactions (other than voice) with the customer devices 205 and/or the servers 242. Such media interactions may be related, for example, to email, voicemail, chat, video, text-messaging, web, social media, co-browsing, etc. The multi-media/social media server 234 may take the form of any IP router conventional in the art with specialized hardware and software for receiving, processing, and forwarding multi-media events and communications.

The knowledge management server 234 may be configured to facilitate interactions between customers and the knowledge system 238. In general, the knowledge system 238 may be a computer system capable of receiving questions or queries and providing answers in response. The knowledge system 238 may include an artificially intelligent computer system capable of answering questions posed in natural language by retrieving information from information sources such as encyclopedias, dictionaries, newswire articles, literary works, or other documents submitted to the knowledge system 238 as reference materials, as is known in the art.

The chat server 240 may be configured to conduct, orchestrate, and manage electronic chat communications with customers. Such chat communications may be conducted by the chat server 240 in such a way that a customer communicates with automated chatbots, human agents, or both. The chat server 240 may perform as a chat orchestration server that dispatches chat conversations among chatbots and available human agents. In such cases, the processing logic of the chat server 240 may be rules driven so to leverage an intelligent workload distribution among available chat resources. The chat server 240 further may implement, manage and facilitate user interfaces (also UIs) associated with the chat feature. The chat server 240 may be configured to transfer chats within a single chat session with a particular customer between automated and human sources. The chat server 240 may be coupled to the knowledge management server 234 and the knowledge systems 238 for receiving suggestions and answers to queries posed by customers during a chat so that, for example, links to relevant articles can be provided.

The web servers 242 provide site hosts for a variety of social interaction sites to which customers subscribe, such as Facebook, Twitter, Instagram, etc. Though depicted as part of the contact center 200, it should be understood that the web servers 242 may be provided by third parties and/or maintained remotely. The web servers 242 may also provide webpages for the enterprise or organization being supported by the contact center 200. For example, customers may browse the webpages and receive information about the products and services of a particular enterprise. Within such enterprise webpages, mechanisms may be provided for initiating an interaction with the contact center 200, for example, via web chat, voice, or email. An example of such a mechanism is a widget, which can be deployed on the webpages or websites hosted on the web servers 242. As used herein, a widget refers to a user interface component that performs a particular function. In some implementations, a widget includes a GUI that is overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Such widgets may include additional user interfaces and be configured to access a variety of local resources (e.g., a calendar or contact information on the customer device) or remote resources via network (e.g., instant messaging, electronic mail, or social networking updates).

The interaction server 244 is configured to manage deferrable activities of the contact center and the routing thereof to human agents for completion. As used herein, deferrable activities include back-office work that can be performed off-line, e.g., responding to emails, attending training, and other activities that do not entail real-time communication with a customer.

The universal contact server (UCS) 246 may be configured to retrieve information stored in the customer database 222 and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer, such as data related to comments from agents, customer communication history, and the like. Each of these data types then may be stored in the customer database 222 or on other modules and retrieved as functionality described herein requires.

The reporting server 248 may be configured to generate reports from data compiled and aggregated by the statistics server 226 or other sources. Such reports may include near real-time reports or historical reports and concern the state of contact center resources and performance characteristics, such as, for example, average wait time, abandonment rate, agent occupancy. The reports may be generated automatically or in response to a request and used toward managing the contact center in accordance with functionality described herein.

The media services server 249 provides audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, audio and video transcoding, secure real-time transport protocol (SRTP), audio or video conferencing, call analysis, keyword spotting, etc.

The analytics module 250 may be configured to perform analytics on data received from a plurality of different data sources as functionality described herein may require. The analytics module 250 may also generate, update, train, and modify predictors or models, such as machine learning model 251 and/or models 253, based on collected data. To achieve this, the analytics module 250 may have access to the data stored in the storage device 220, including the customer database 222 and agent database 223. The analytics module 250 also may have access to the interaction database 224, which stores data related to interactions and interaction content (e.g., audio and transcripts of the interactions and events detected therein), interaction metadata (e.g., customer identifier, agent identifier, medium of interaction, length of interaction, interaction start and end time, department, tagged categories), and the application setting (e.g., the interaction path through the contact center). The analytic module 250 may retrieve such data from the storage device 220 for developing and training algorithms and models. It should be understood that, while the analytics module 250 is depicted as being part of a contact center, the functionality described in relation thereto may also be implemented on customer systems (or, as also used herein, on the “customer-side” of the interaction) and used for the benefit of customers.

The machine learning model 251 may include one or more artificial intelligence-based models, including machine learning models, such as neural networks, deep learning models as well as other types as described herein. As an example, the machine learning model 251 may be configured to predict behavior. Such behavioral models may be trained to predict the behavior of customers and agents in a variety of situations so that interactions may be personally tailored to customers and handled more efficiently by agents. As another example, the machine learning model 251 may be configured to predict aspects related to contact center operation and performance. In other cases, for example, the machine learning model 251 also may be configured to perform natural language processing and, for example, provide intent recognition and the like.

The analytics module 250 may further include an optimization system 252. The optimization system 252 may include one or more models 253, which may include the machine learning model 251, and an optimizer 254. The optimizer 254 may be used in conjunction with the models 253 to minimize a cost function subject to a set of constraints, where the cost function is a mathematical representation of desired objectives or system operation. Because the models 253 are typically non-linear, the optimizer 254 may be a nonlinear programming optimizer. It is contemplated, however, that the optimizer 254 may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like. The analytics module 250 may utilize the optimization system 252 as part of an optimization process by which aspects of contact center performance and operation are optimized or, at least, enhanced. This, for example, may include aspects related to the customer experience, agent experience, interaction routing, natural language processing, intent recognition, allocation of system resources, system analytics, or other functionality related to automated processes.

### Agent Authentication

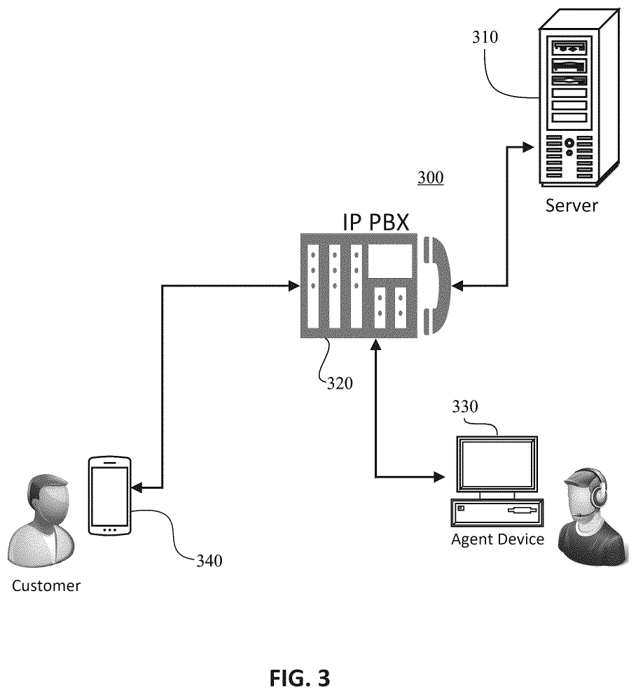

Turning now to FIGS. 3-6, the functionality of methods and systems related to agent authentication will be described. Before proceeding with this, though, some background will be provided highlighting some operational shortcomings that the present invention is intended to address.

Enterprises, such as businesses and organizations, regularly need to communicate with customers, users, and other persons with whom they have an existing relationship (referred to generally simply as “customers”) for a variety of reasons. Many times the most efficient way to conduct such communication is via a telephone call. However, it is often difficult or impossible to reach customers in the way because customers are not sure whether they are speaking with an authentic representative of the enterprise that the caller claims to represent. Put another way, customers are leery about doing any sort of transaction over an incoming call because of the rise of call spoofing and other fraudulent practices.

Caller identification (Caller ID) was one of the most trusted ways of identifying who is calling and is still used to filtering incoming calls. Telecommunication networks are designed in such a way that the Caller ID is usually delivered to the called device by the telecommunication operators. With a traditional phone system, it is hard to spoof Caller ID. But with the advent of IP Telephony, a caller can easily spoof Caller ID using techniques and tools freely available on the Internet. More importantly, the caller can be anywhere in the world where Internet Protocol (IP) connectivity is available to perform these operations. The rise of these practices has made all callers extremely cautions about receiving incoming calls. It is almost impossible for business to reach out to via telephone and connect with even longterm existing customers because of this environment. There is, therefore, a need for a system, methods and systems for authenticating calls.

With reference now to FIG. 3, a simplified network diagram is shown of a system 300 in accordance with exemplary embodiments of the present invention and/or with which exemplary embodiments of the present invention may be enabled or practiced. As will be appreciated, components of the system 300 may be associated with a business or other enterprises (which will henceforth be referred to generally as “business”). In other cases, the components of the system 300 may be associated with a contact center, such as contact center 200 shown in FIG. 2, that is associated with or handles customer interactions for the business. Components associated with the business may include one or more servers 310, an IP PBX 320, and one or more agent devices 330. The depicted server 310 may be configured to transmit or stream various data packets to one or more agent devices 330 and/or one or more customer devices 340 as necessary for achieving the functionality described herein. As an example, the server 310 may communicate with an agent device for delivering data to an agent to enable customer assistance. Further, the server 310 may download an application for operation on the customer device 340 of a customer, where the application is configured to enable the customer to connect with the business and conduct transactions therewith. The server 310 may be housed on the premise of the business or associated contact center or in a cloud environment.

In the example of FIG. 3, the IP PBX 320 is an Internet Protocol private branch exchange, which, as will be appreciated, is a system that connects telephone extensions to a public switched telephone network (“PSTN”) and provides internal communication, for example, for the business. Additionally, an IP PBX is a PBX system with IP connectivity and may be used to provide audio, video, or instant messaging communication utilizing the TCP/IP protocol stack. Voice over IP (“VOIP”) gateways can be combined with traditional PBX functionality to allow businesses or other organizations to use their managed intranet to help reduce phone expenses as well as take advantage of the benefits of a single network for voice and data. As will be appreciated, the IP PBX 320 may exist as a physical hardware device, a software platform, a combination thereof, or other such device fulfilling the described functionality. In alternative embodiments, related functionality may be provided by a switch/media gateway, a call controller, an interactive media response (“IMR”) server, and/or a routing server, such as the examples of such components described above in relation to the contact center 200. The system 300 may further include multiple agent devices 330, though only one is show in the provided example. An agent may use an agent device 330 to initiate telephone calls to customers via the customer's device 340, such as may occur as part of an outbound campaign or to resolve an pending customer issue. The components of FIG. 3 may interact in accordance with functionality that will now be discussed.

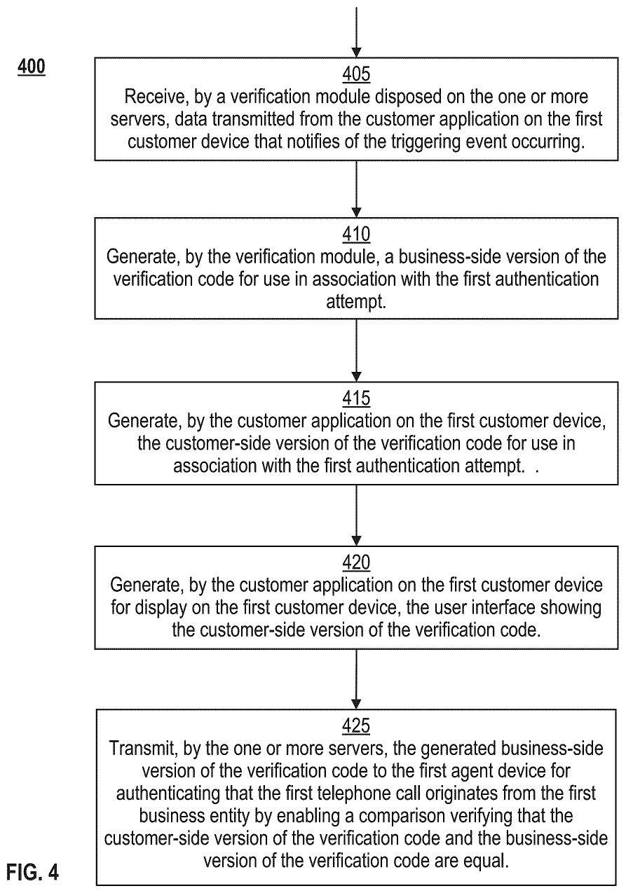

With reference to FIG. 4, an exemplary agent authentication process or method 400 is shown according to an embodiment of the present invention. The method 400 may be used by a customer to verify that an incoming telephone call originated from a business entity known to or trusted by the customer.

Initially, before the operation of method 400, the business entity may download or transmit a customer application to that operates on a customer device of the customer. The customer device, for example, may be a smart phone. Thus, the business entity may transmit from one or more servers (such as the server 310 of FIG. 3) associated with the business entity the customer application to the customer device for installation thereon. The customer application then may enable certain of the steps of the method 400 via certain functionality. That is, the customer application may be configured to determine an occurrence of a triggering event signaling an authentication attempt for authenticating a telephone call to a one of the customers. The customer application may be configured to generate, in response to determining the occurrence of the triggering event, a customer-side version of a verification code for use in each authentication attempt. Further, the customer application may be configured to generate one or more user interfaces on the customer device that displays the generated customer-side version of a verification code.

In accordance with an exemplary embodiment, the customer application may include a cryptographic authentication device. The cryptographic authentication device may include a software token that is configured to generate a new six-digit number upon demand and that changes at regular time intervals. The generated digit sequences may be derived cryptographically from the current time and a secret key unique to each token. The server of the business entity may include a verification module that stores the secret key related to the customer so that the business entity may generate a business-side version of the verification code. As will be seen, the business-side version of the verification code can be used to verify a call to customer by allowing the customer to match it to the customer-side version.

The authentication method 400 may be performed in relation to each authentication attempt by a customer. When described in relation to an exemplary first authentication attempt related to authenticating that a first telephone call initiated from a first agent device by an agent to a first customer device associated with a first customer originates from a first business entity, the authentication method 400 may include the following steps.

The method 400 begins, at step 405, by receiving, by the one or more servers, data transmitted from the customer application on the first customer device that notifies of the triggering event occurring. Examples of the triggering will be discussed below.

At step 410, the method 400 continues by generating, by the one or more servers, a business-side version of the verification code for use in association with the first authentication attempt.

At step 415, the method 400 continues by generating, by the customer application on the first customer device, the customer-side version of the verification code for use in association with the first authentication attempt.

At step 420, the method 400 continues by generating, by the customer application on the first customer device for display on the first customer device, the user interface showing the customer-side version of the verification code.

At step 425, the method 400 continues by transmitting, by the one or more servers, the generated business-side version of the verification code to the first agent device for authenticating that the first telephone call originates from the first business entity by enabling a comparison verifying that the customer-side version of the verification code and the business-side version of the verification code are equal. The customer may then request that the agent state the verification code (i.e., the business-side version) so that the customer can compare it to the customer-side version. If the two codes match, the customer has verified the agent as being associated with the business entity associated with the customer application.

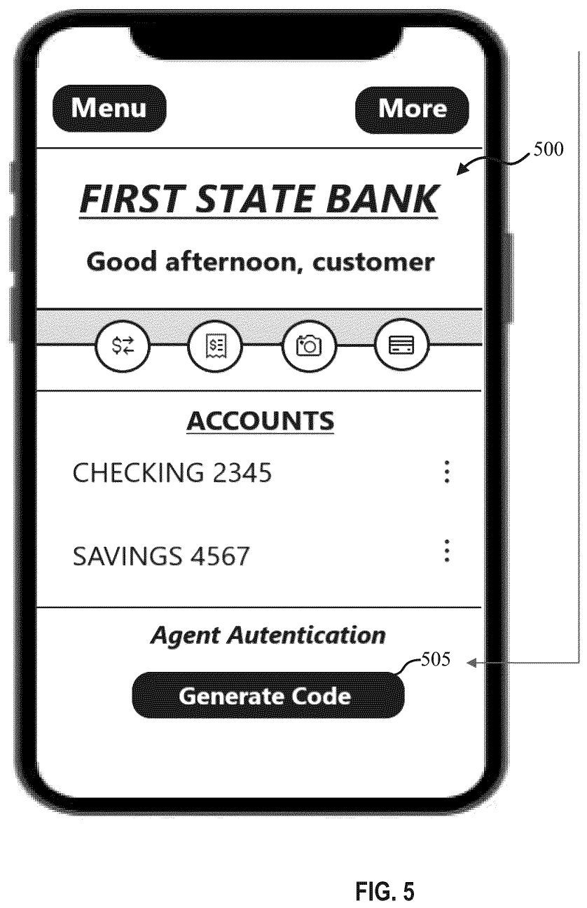

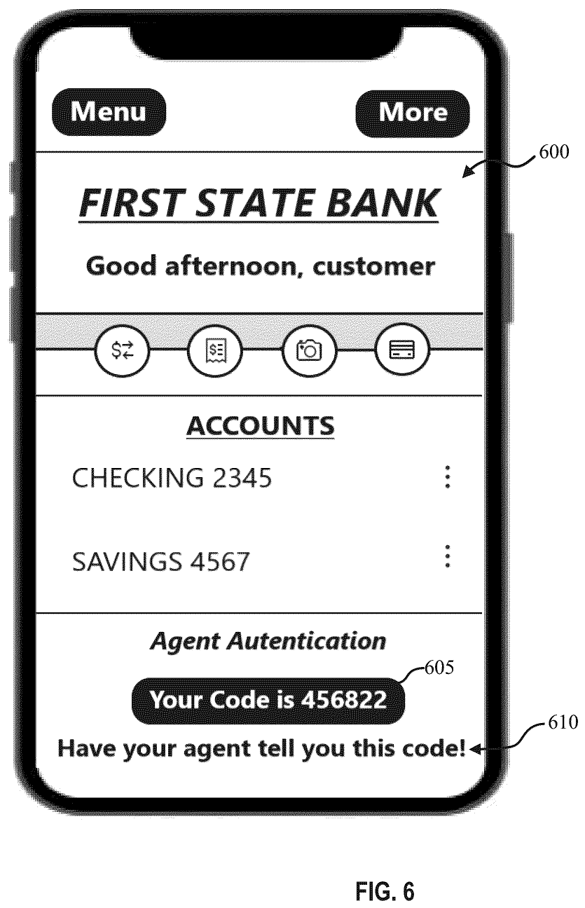

In exemplary embodiments, the customer application identifies its association with the business entity, for example, via the user interfaces that it generates and the text displayed thereon. Further, the customer application may include functionality that allows customers to place orders for products and/or services offered by the business entity through the customer application. See example user interfaces provided below in relation to FIGS. 5 and 6.

In exemplary embodiments, the customer application may include a software token. The customer-side version of the verification code may be a one-time password generated by the software token. As stated, the one or more servers associated with the business entity may include a verification module that has a version of the software token. The software token of the customer application and the verification module may each have a shared secret key that is used by the software token of the customer application and the verification module to generate the customer-side version of the verification code and the business-side version of the verification code, respectively.

In exemplary embodiments, the data transmitted from the customer application on the first customer device that notifies of the triggering event occurring may further include a customer identifier for the first customer. In such cases, the authentication process may further include the step of identifying, based on the customer identifier, the first agent device from among a plurality of such agent devices as being the particular agent device that is conducting the first telephone call with the first customer. In response to identifying the first agent device as the particular agent device conducting the first telephone call, the authentication process may further include the step of generating a user interface on the first agent device displaying the business-side version of the verification code. Alternatively, in response to identifying the first agent device as the particular agent device conducting the first telephone call, the authentication process may further include the steps of: providing audio data for generating automated speech communicating the business-side version of the verification code; and generating the automated speech during the first telephone call so to communicate the business-side version of the verification code to the first customer. In this way, the agent is not made aware of the verification code and does not have to perform the function of reading out the verification code to the customer.

In exemplary embodiments, the triggering event may be linked to several different types of occurrences or happenings depending on desired operations. For example, the triggering event may be the expiration of a recurring time period or countdown. For example, a new verification code may be generated periodically, for example, every time a 20 or 30 second countdown expires, with the new verification code being usable until the next countdown expires. In other embodiments, the triggering event may include simply activation of the customer application. The triggering event may further include activation of the customer application concurrent with an ongoing telephone call.

With reference to FIGS. 5 and 6, the triggering event may further be linked, in combination with a recurring countdown or as a single triggering event, input received from the customer requesting generation of the verification code. For example, with reference to FIG. 5, the customer application may be configured to generate a user interface 500 on the customer device (i.e., smart phone) that displays a selectable portion 505 that instructs the customer (e.g., “Agent Authentication: Generate Code”) to select the selectable portion 505 when the customer wants to generate the customer-side version of the verification code for authenticating a given telephone call. In such cases, the triggering event may include receiving input at the customer device indicating selection of the selectable portion 505 by the customer. With reference now to FIG. 6, once the selectable portion is selected, a second user interface 600 may be generated that displays the current verification code 605. Instructions 610 may be included on the second user interface 600 instructing the customer that they should have the agent say the displayed code in order to verify the agent. Optionally, the generated the verification code that is displayed on the second user interface 600 may be refreshed periodically at the expiration of a predefined countdown period, as described above.

As one of skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, each of the possible iterations is not provided or discussed in detail, though all combinations and possible embodiments embraced by the several claims below or otherwise are intended to be part of the instant application. Further, it should be apparent that the foregoing relates only to the described embodiments of the present application and that numerous changes and modifications may be made herein without departing from the spirit and scope of the present application as defined by the following claims and the equivalents thereof.

That which is claimed:

1. A method of verifying that incoming telephone calls to respective customers originate from a business entity known to the customers, the method comprising the steps of:
transmitting, from one or more servers associated with the business entity, a customer application to a customer device of each of the customers for installation on the customer device, wherein the customer application identifies the business entity associated therewith and is configured to:
determine an occurrence of a triggering event signaling an authentication attempt for authenticating a telephone call to a one of the customers;
generate, in response to determining the occurrence of the triggering event, a customer-side version of a verification code for use in each authentication attempt; and
generate a user interface on the customer device that displays the generated customer-side version of a verification code;
performing an authentication process in relation to each authentication attempt, wherein, when described in relation to an exemplary first authentication attempt related to authenticating that a first telephone call initiated from a first agent device by an agent to a first customer device associated with a first customer originates from a first business entity, the authentication process comprises the steps of:
receiving, by a verification module disposed within the one or more servers, data transmitted from the customer application on the first customer device that notifies of the triggering event occurring;
generating, by the verification module, a business-side version of the verification code for use in association with the first authentication attempt;
generating, by the customer application on the first customer device, the customer-side version of the verification code for use in association with the first authentication attempt;
generating, by the customer application on the first customer device for display on the first customer device, the user interface showing the customer-side version of the verification code;
transmitting, by the one or more servers, the generated business-side version of the verification code to the first agent device for authenticating that the first telephone call originates from the first business entity by enabling a comparison verifying that the customer-side version of the verification code and the business-side version of the verification code are equal.

2. The method of claim 1, wherein the customer application comprises a software token, and the customer device comprises a smart phone.

3. The method of claim 2, wherein the customer-side version of the verification code comprises a one-time password generated by the software token.

4. The method of claim 2, wherein the software token of the customer application and the verification module on the one or more servers associated with the business entity each comprises a shared secret key that is used by the software token of the customer application and the verification module to generate the customer-side version of the verification code and the business-side version of the verification code, respectively.

5. The method of claim 4, wherein the customer application is further configured to:
generate a user interface on the customer device that displays a selectable portion that instructs the customer to select the selectable portion when the customer wants to generate the customer-side version of the verification code for authenticating a given telephone call.

6. The method of claim 5, wherein the triggering event comprises receiving input indicating selection of the selectable portion.

7. The method of claim 4, wherein the triggering event comprises an expiration of a recurring countdown such that the verification code is generated periodically and usable until a current one of the recurring countdown expires.

8. The method of claim 4, wherein the triggering event comprises an activation of the customer application.

9. The method of claim 4, wherein the data transmitted from the customer application on the first customer device that notifies of the triggering event occurring further includes a customer identifier for the first customer.

10. The method of claim 9, wherein the authentication process further comprises the step of:
identifying, based on the customer identifier, the first agent device from among a plurality of such agent devices as being the particular agent device that is conducting the first telephone call with the first customer.

11. The method of claim 10, wherein the authentication process further comprises the step of:
generating, in response to identifying the first agent device as the particular agent device conducting the first telephone call, a user interface on the first agent device displaying the business-side version of the verification code.

12. The method of claim 9, wherein the authentication process further comprises the steps of:
providing, in response to identifying the first agent device as the particular agent device conducting the first telephone call, audio data for generating automated speech communicating the business-side version of the verification code; and
generating the automated speech during the first telephone call so to communicate the business-side version of the verification code to the first customer.

13. The method of claim 4, wherein the customer application is further configured to place an order for a product or service offered by the business entity.

14. A system for verifying that incoming telephone calls to respective customers originate from a business entity known to the customers, the system comprising:
a processor; and
a memory storing instructions which, when executed by the processor, cause the processor to perform the steps of:
transmitting, from one or more servers associated with the business entity, a customer application to a customer device of each of the customers for installation on the customer device, wherein the customer application identifies the business entity associated therewith and is configured to:
determine an occurrence of a triggering event signaling an authentication attempt for authenticating a telephone call to a one of the customers;
generate, in response to determining the occurrence of the triggering event, a customer-side version of a verification code for use in each authentication attempt; and
generate a user interface on the customer device that displays the generated customer-side version of a verification code;
performing an authentication process in relation to each authentication attempt, wherein, when described in relation to an exemplary first authentication attempt related to authenticating that a first telephone call initiated from a first agent device by an agent to a first customer device associated with a first customer originates from a first business entity, the authentication process comprises the steps of:
receiving, by a verification module disposed within the one or more servers, data transmitted from the customer application on the first customer device that notifies of the triggering event occurring;
generating, by the verification module, a business-side version of the verification code for use in association with the first authentication attempt;
generating, by the customer application on the first customer device, the customer-side version of the verification code for use in association with the first authentication attempt;
generating, by the customer application on the first customer device for display on the first customer device, the user interface showing the customer-side version of the verification code; and
transmitting, by the one or more servers, the generated business-side version of the verification code to the first agent device for authenticating that the first telephone call originates from the first business entity by enabling a comparison verifying that the customer-side version of the verification code and the business-side version of the verification code are equal.

15. The system of claim 14, wherein the customer application comprises a software token, and the customer device comprises a smart phone.

16. The system of claim 15, wherein the customer-side version of the verification code comprises a one-time password generated by the software token.

17. The system of claim 16, wherein the software token of the customer application and the verification module on the one or more servers associated with the business entity each comprises a shared secret key that is used by the software token of the customer application and the verification module to generate the customer-side version of the verification code and the business-side version of the verification code, respectively.

18. The system of claim 17, wherein the customer application is further configured to:
generate a user interface on the customer device that displays a selectable portion that instructs the customer to select the selectable portion when the customer wants to generate the customer-side version of the verification code for authenticating a given telephone call;
wherein the triggering event comprises receiving input indicating selection of the selectable portion.

19. The system of claim 17, wherein the triggering event comprises an expiration of a recurring countdown such that the verification code is generated periodically and usable until a current one of the recurring countdown expires.

20. The system of claim 17, wherein the data transmitted from the customer application on the first customer device that notifies of the triggering event occurring further includes a customer identifier for the first customer; and
wherein the authentication process further comprises the step of:
identifying, based on the customer identifier, the first agent device from among a plurality of such agent devices as being the particular agent device that is conducting the first telephone call with the first customer; and
generating, in response to identifying the first agent device as the particular agent device conducting the first telephone call, a user interface on the first agent device displaying the business-side version of the verification code.
